(19) United States
(12) Patent Application Publication
(10) Pub. No.: US 2011/0188359 A1
(43) Pub. Date: Aug. 4, 2011

(54) Optical Disk Apparatus, Semiconductor Integrated Circuit, and Laser Diode Driver

(75) Inventors: Shinichi Ejima, Kanagawa (JP); Motokuni Saeki, Kawasaki-shi (JP); Jun Sakamoto, Kawasaki-shi (JP); Kenji Oishi, Kawasaki-shi (JP); Aritsune Nagamura, Kawasaki-shi (JP)

(73) Assignee: Renesas Electronics Corporation, Kawasaki-shi (JP)

(21) Appl. No.: 13/016,628

(22) Filed: Jan. 28, 2011

(30) Foreign Application Priority Data
Jan. 29, 2010 (JP) 2010-018051

(51) Int. Cl. G11B 27/22; G11B 27/36; G11B 20/10; G11B 7/0045

(52) U.S. Cl. 369/47.5; 369/53.25; 369/47.49; 369/59.12; G9B/27.052; G9B/27.026; G9B/20.009; G9B/7.01

(57) ABSTRACT

In an optical disk apparatus, the same signal path is used to both reduce an interchannel phase shift in write strategy signals and also to perform the actual writing to the disk. The optical disk apparatus includes a laser diode, a laser diode driver, and a semiconductor integrated circuit. The semiconductor integrated circuit includes a write strategy circuit and a control unit for controlling the operation of the write strategy circuit. Information collection for interchannel delay adjustment is performed through the use of the same signal path as that used for transmitting pulse signals from a pulse generation circuit to the laser diode driver for actual writing to an optical disk. Based thereon, an interchannel delay amount for applying laser light to the optical disk is set, thereby reducing the interchannel phase shift in the write strategy signals.

### CROSS-REFERENCE TO RELATED APPLICATIONS

The disclosure of Japanese Patent Application No. 2010-18051 filed on Jan. 29, 2010 including the specification, drawings and abstract is incorporated herein by reference in its entirety.

### BACKGROUND OF THE INVENTION

The present invention relates to a technique for writing information by applying laser light to an optical disk.

When an optical disk drive writes information to an optical disk as a recording medium, it needs to accurately control emission timings of a semiconductor laser and light emission time periods. Such a semiconductor laser emission control circuit is generally called a write strategy circuit, and a digital signal of write pulse emission timing information outputted from the write strategy circuit is generally called a write strategy signal. The write strategy circuit is often included in an LSI (Large Scale Integration), generally called a DSP (Digital Signal Processor), for controlling the optical disk drive.

Pulsed laser light applied from a laser diode to a recording medium is often formed of a complex shape having a plurality of power levels, and the write strategy circuit generates one write strategy signal for one power level; therefore, write strategy signals of a plurality of channels are needed to transmit write pulse information having a plurality of power levels.

Recently, systems of high writing density such as BD (Blu-ray Disc) have been developed. Writing information to a recording medium of high writing density requires smaller spot sizes of applied laser light and shorter lengths of write marks, which requires accurate control of the semiconductor laser. Accordingly, it is necessary to transmit write strategy signals generated by the write strategy circuit to a laser diode driver (LDD) with high accuracy.

Japanese Unexamined Patent Publication No. 2006-120252 (Patent Document 1) and Japanese Unexamined Patent Publication No. 2007-134006 (Patent Document 2) describe techniques relating to an optical disk writing apparatus.

Patent Document 1 describes a technique for stabilizing writing quality by writing with desired write waveforms in an optical disk writing apparatus.

Patent Document 2 describes an optimization processing technique of a write strategy for determining the pulse width of a top pulse, a last pulse, or a cooling pulse in a light emission pulse group for forming one write mark.

### SUMMARY OF THE INVENTION

An optical pickup provided with the laser diode and the laser diode driver needs to be movable in the radial direction of the optical disk, and is therefore generally coupled through a flexible cable to a PCB (Printed Circuit Board) provided with a DSP. Accordingly, the transmission distance from the write strategy circuit to the laser diode driver of the optical pickup ranges from a few centimeters to about 20 centimeters. An interchannel timing shift (phase shift) in the write strategy signals may occur due to the distance and impedance difference between channels in a transmission line, device characteristic change associated with a temperature rise in the optical disk apparatus, or the like.

The present inventors have investigated the effect of the interchannel timing shift in the write strategy signals.

FIG. 3 shows the relationship between an NRZI signal inputted to the write strategy circuit and a write clock signal CLK which is an internal signal of the DSP.

In the DSP, the NRZI signal is generated in synchronization with the write clock signal CLK. The write strategy circuit generates LVDS (Low Voltage Differential Signaling) signals based on the NRZI (Non Return to Zero Inversion) signal. The LVDS signals are 4-channel pulse signals (write strategy signals) containing W1DISP, W2DISP, W3DISP, and W4DISP. The laser diode driver combines the LVDS signals, thereby generating a laser diode driving signal for driving the laser diode. Power levels Pw, Pm, Pe, and Pb of this laser diode driving signal denote a write power, a middle power, an erase power, and a bias power, respectively.

One period of the write clock signal CLK is represented by 1 T, and the absolute time of 1 T is determined by the frequency of the write clock signal. The absolute time of 1×-speed BD is about 15 ns. The NRZI signal is a digital signal into which information to be written to the recording medium is encoded by a modulation unit (not shown) incorporated in the DSP, and generally contains high-level durations and low-level durations which are integral multiples of 1 T and which are, in the Blu-ray system, 2 T, 3 T, 4 T, . . . , 8 T, and 9 T. The high-level durations and low-level durations of the NRZI signal correspond to the lengths of marks and spaces written to the optical disk recording medium. However, whether the high-level durations of the NRZI signal correspond to marks or correspond to spaces depends on the system.

It is desirable that the NRZI signal inputted to the write strategy circuit be identical to a digital signal obtained by performing signal processing such as equalization and slicing on a reproduction signal obtained by reproducing marks and spaces written on the optical disk recording medium by the writing laser of the optical pickup. For example, when a mark written with the duration of 2 T in the NRZI signal is reproduced as 3 T due to poor accuracy of the write strategy signals inputted to the laser diode driver, a data error occurs. Generally, in the optical disk system, an error correction function is incorporated in a system for decoding a reproduced digital signal into original write information, and enables correction of a small number of data errors. However, if there are too many data errors, the error correction function is unable to correct the errors, which leads to loss of written information. For this reason, it is very important to accurately transmit the write strategy signals generated from the NRZI signal etc. inputted to the write strategy circuit to the laser diode driver. A mark written on the optical disk is formed by applying the writing laser to and chemically changing material. The length of the mark and the irradiation time of the writing laser do not match, and the irradiation time of the laser is generally shorter than the length of the mark to be formed. It is necessary to accurately control the optimal irradiation time of the laser obtained by experiment or the like beforehand to accurately form the mark. In general, the laser irradiation time is controlled with a resolution of (1/n)T obtained by dividing 1 T by an integer. Although the value of n depends on the system, n is approximately equal to 16 to 64 in the Blu-ray system.

As described above, a transmission line exists between the DSP and the laser diode driver, which may cause an interchannel timing shift (phase shift) in the write strategy signals. Since an occurrence of an interchannel phase shift in the write strategy signals degrades the writing quality of the optical disk, very high timing accuracy is required for the write strategy signals. Particularly, in the case of high-speed writing to a high-density recording medium such as BD, it is important to maintain the interchannel timing accuracy at a high level to maintain good writing quality.

According to Patent Document 1, pulses for use in adjustment are generated by a timing-shift detection signal generation circuit included in the DSP, and the output of the timing-shift detection signal generation circuit is transmitted to the laser diode driver by switching signal transmission paths. Therefore, different signal paths are used in adjustment and in actual writing. The present inventors have investigated this point and found that the same path should be used in adjustment and in actual writing to improve the adjustment accuracy of the interchannel phase shift in the write strategy signals.

Further, Patent Document 2 does not take into consideration the adjustment accuracy of the interchannel phase shift in the write strategy signals.

It is an object of the present invention to reduce the interchannel phase shift in the write strategy signals by using the same path in adjusting the interchannel phase shift in the write strategy signals and in actual writing in an optical disk apparatus. Further, it is another object of the invention to provide a semiconductor integrated circuit and a laser diode driver applied to such an optical disk apparatus.

The above and other objects and novel features of the present invention will become apparent from the description of this specification and the accompanying drawings.

A typical aspect of the invention disclosed in the present application will be briefly described as follows.

An optical disk apparatus includes a laser diode for generating laser light applied to an optical disk, a laser diode driver for driving the laser diode, and a semiconductor integrated circuit capable of controlling operation of the laser diode driver. The laser diode driver is coupled to the semiconductor integrated circuit through a transmission line. The semiconductor integrated circuit includes a write strategy circuit for controlling emission of the laser diode and a control unit for controlling operation of the write strategy circuit. The write strategy circuit includes a pulse generation circuit capable of generating multiple-channel pulse signals based on information for writing to the optical disk and an interchannel delay adjustment circuit capable of adjusting interchannel delay in pulse signals outputted from the pulse generation circuit. The laser diode driver includes an interchannel phase shift determination circuit for determining an interchannel phase shift in the multiple-channel pulse signals transmitted from the semiconductor integrated circuit through the transmission line. The control unit causes the pulse generation circuit to generate pulse signals for interchannel delay adjustment, and changes an interchannel delay amount in the interchannel delay adjustment circuit by a predetermined adjustment unit. Further, the control unit sets the interchannel delay amount for applying laser light to the optical disk to the interchannel delay adjustment circuit based on a determination result obtained by the interchannel phase shift determination circuit with each change of the interchannel delay amount in the interchannel delay adjustment circuit.

A typical effect of the invention disclosed in the present application will be briefly described as follows.

It is possible to reduce the interchannel phase shift in the write strategy signals by using the same path in adjusting the interchannel phase shift in the write strategy signals and in actual writing in the optical disk apparatus.

### BRIEF DESCRIPTION OF THE DRAWINGS

FIG. 1 is a general block diagram of an optical disk apparatus according to the present invention;

FIG. 2 is a detailed block diagram of a main part in the optical disk apparatus shown in FIG. 1;

FIG. 3 is a signal waveform diagram of the main part in the optical disk apparatus;

FIG. 4 is a flowchart showing interchannel delay adjustment of write strategy signals (first mode of operation) in the optical disk apparatus shown in FIG. 1;

FIG. 5 is a flowchart showing write emission control (second mode of operation) using adjustment results obtained by interchannel delay adjustment in the optical disk apparatus shown in FIG. 1;

FIG. 6 is an operation timing diagram of exemplary write strategy circuit output waveforms in the optical disk apparatus shown in FIG. 1;

FIG. 7 is an operation timing diagram of exemplary delay/advance determination circuit waveforms in the optical disk apparatus shown in FIG. 1;

FIG. 8 is a flowchart showing setting the delay amount in the interchannel delay adjustment circuit in the optical disk apparatus shown in FIG. 1; and

FIG. 9 is a waveform diagram of assistance in explaining main operations in the optical disk apparatus shown in FIG. 1.

### DESCRIPTION OF THE PREFERRED EMBODIMENTS

### 1. Outline of Embodiments

First, the outline of typical embodiments of the invention disclosed in the present application will be described. Reference numerals in the drawings that refer to with parentheses applied thereto in the outline description of the typical embodiments are merely illustration of ones contained in the concepts of components marked with the reference numerals.

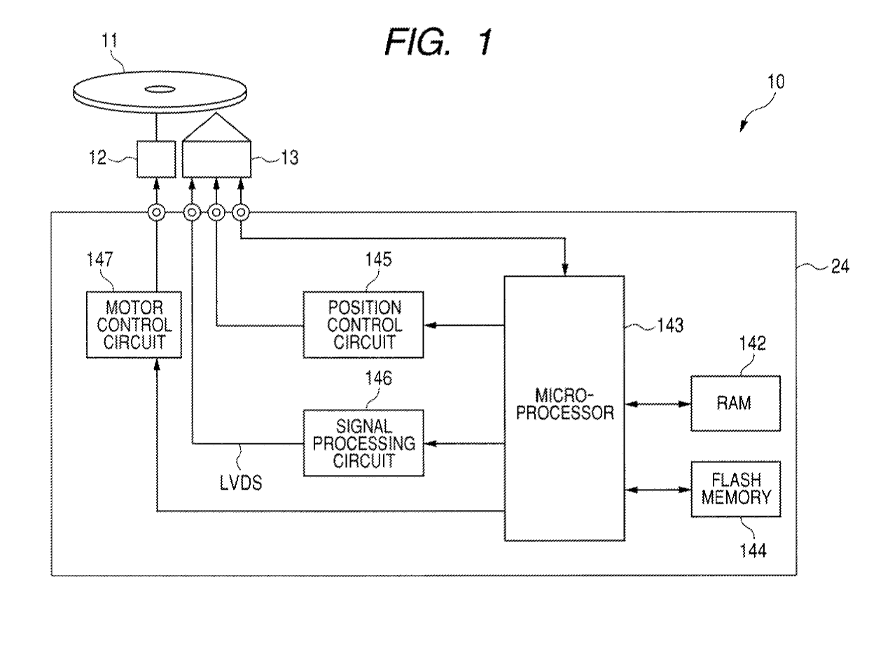

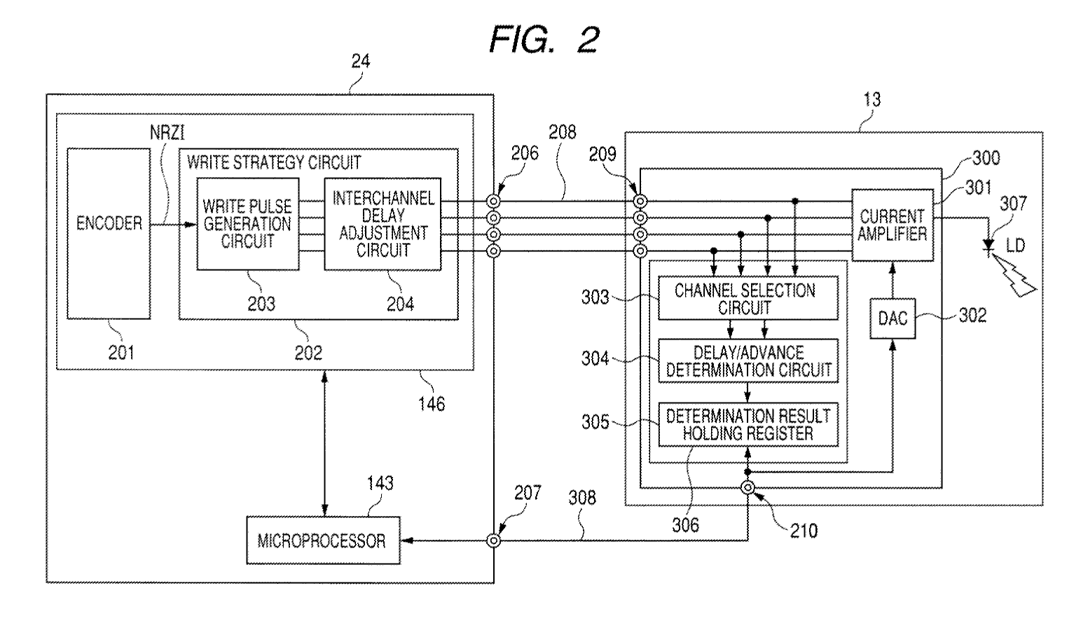

As seen in FIGS. 1 and 2, an optical disk apparatus (10) according to one embodiment of the invention includes a laser diode (307) for generating laser light applied to an optical disk, a laser diode driver (300) for driving the laser diode, and a semiconductor integrated circuit (24) capable of controlling operation of the laser diode driver. The laser diode driver is coupled to the semiconductor integrated circuit through a transmission line.

The semiconductor integrated circuit includes a write strategy circuit (202) for controlling emission of the laser diode and a control unit (143), which may be a microprocessor, for controlling operation of the write strategy circuit. The write strategy circuit includes a pulse generation circuit (203) capable of generating multiple-channel pulse signals based on information for writing to the optical disk and an interchannel delay adjustment circuit (204) capable of adjusting interchannel delay in pulse signals outputted from the pulse generation circuit.

The laser diode driver includes an interchannel phase shift determination circuit (306) for determining an interchannel phase shift in the multiple-channel pulse signals transmitted from the semiconductor integrated circuit through the transmission line. The control unit (143) causes the pulse generation circuit (203) to generate pulse signals for interchannel delay adjustment, and changes an interchannel delay amount in the interchannel delay adjustment circuit (204) by a predetermined adjustment unit. Further, the control unit (143) sets the interchannel delay amount for applying laser light to the optical disk in the interchannel delay adjustment circuit (204) based on a determination result obtained by the interchannel phase shift determination circuit (306) with each change of the interchannel delay amount in the interchannel delay adjustment circuit (204).

According to the above configuration, the control unit (143) causes the pulse generation circuit (203) to generate pulse signals for interchannel delay adjustment, changes an interchannel delay amount in the interchannel delay adjustment circuit (204) by a predetermined adjustment unit, and sets the interchannel delay amount to the interchannel delay adjustment circuit (204) based on a determination result obtained by the interchannel phase shift determination circuit (306) with each change of the interchannel delay amount in the interchannel delay adjustment circuit (204). This makes it possible to collect information for interchannel delay adjustment through the use of the same signal path as that used for transmitting the pulse signals from the pulse generation circuit (203) to the laser diode driver (300) in actual writing to the optical disk, which can improve the adjustment accuracy of the interchannel phase shift in the write strategy signals.

The semiconductor integrated circuit (24) includes at least one semiconductor integrated circuit first terminal (206) for transmitting an output signal of the interchannel delay adjustment circuit (204) to the transmission line and a semiconductor integrated circuit information communication terminal (207) for enabling the semiconductor integrated circuit (24) to receive the determination result obtained by the interchannel phase shift determination circuit (306) with each change of the interchannel delay amount in the interchannel delay adjustment circuit (204).

With the above configuration, it is possible to transmit the output signal of the interchannel delay adjustment circuit (204) to the transmission line through the semiconductor integrated circuit first terminal (206) and to receive, in the semiconductor integrated circuit through the semiconductor integrated circuit information communication terminal (207), the determination result obtained by the interchannel phase shift determination circuit (306) with each change of the interchannel delay amount in the interchannel delay adjustment circuit (204).

The control unit (143) has a first control mode for controlling information collection for adjusting interchannel delay in the pulse signals outputted from the pulse generation circuit (203) and a second control mode for controlling application of laser light to the optical disk based on the pulse signals outputted from the pulse generation circuit (203). Further, the control unit (143) determines in the second control mode whether or not the determination result obtained by the interchannel phase shift determination circuit (306) exists in the semiconductor integrated circuit (24). If the determination result obtained by the interchannel phase shift determination circuit (306) does not exist in the semiconductor integrated circuit (24), the control unit (143) transitions to the first control mode, causes the pulse generation circuit (203) to generate pulse signals for interchannel delay adjustment, and changes an interchannel delay amount in the interchannel delay adjustment circuit (204) by the predetermined adjustment unit. At this time, the control unit (143) receives, in the semiconductor integrated circuit (24), a determination result obtained from the interchannel phase shift determination circuit (306) through the semiconductor integrated circuit information communication terminal (207).

The determination result obtained from the interchannel phase shift determination circuit (306) can be stored in an appropriate storage medium such as a flash memory (144) in the semiconductor integrated circuit (24). If the determination result obtained from the interchannel phase shift determination circuit (306) does not exist in the flash memory (144), the control unit (143) transitions to the first control mode, causes the pulse generation circuit (203) to generate pulse signals for interchannel delay adjustment, and changes an interchannel delay amount in the interchannel delay adjustment circuit (204) by the predetermined adjustment unit, thereby to perform information collection for interchannel delay adjustment.

If the determination result obtained from the interchannel phase shift determination circuit (306) exists in the semiconductor integrated circuit (24), the control unit (143) sets the interchannel delay amount in the interchannel delay adjustment circuit (204) based on the determination result.

If the determination result obtained by the interchannel phase shift determination circuit (306) is stored in an appropriate storage medium such as a flash memory (144) in the semiconductor integrated circuit (24), the control unit (143) sets the interchannel delay amount in the interchannel delay adjustment circuit (204) based on the determination result, and can eliminate information collection for interchannel delay adjustment.

The control unit (143) determines whether or not a condition for interchannel delay amount adjustment is triggered, and if the control unit (143) determines that the condition for interchannel delay amount adjustment is triggered; whether or not the determination result obtained by the interchannel phase shift determination circuit (306) exists in the semiconductor integrated circuit (924), the control unit causes the pulse generation circuit (203) to generate pulse signals for interchannel delay adjustment. Further, the control unit (143) changes an interchannel delay amount in the interchannel delay adjustment circuit (204) by the predetermined adjustment unit, and receives, in the semiconductor integrated circuit (24), a determination result obtained by the interchannel phase shift determination circuit (306) through the semiconductor integrated circuit information communication terminal (207).

A condition for interchannel delay amount adjustment is triggered, for example, when temperature in the optical disk apparatus reaches a predetermined value. The temperature in the optical disk apparatus (10) can be detected by a temperature sensor provided in the optical disk apparatus. Since an interchannel timing shift (phase shift) in the write strategy signals may occur due to device characteristic change or the like associated with a temperature rise in the optical disk apparatus, detecting when the internal temperature of the optical disk apparatus reaches the predetermined value and performing interchannel delay amount adjustment as described above can improve the reliability of the optical disk apparatus.

The laser diode driver (300) includes at least one driver input first terminal (209) for allowing the laser diode driver (300) to receive the multiple-channel pulse signals transmitted from the semiconductor integrated (24) circuit through the transmission line and a driver information communication second terminal (210) for enabling information communication with the semiconductor integrated circuit (24).

It is possible to receive, in the laser diode driver (300) through the driver input first terminal (209), the multiple-channel pulse signals transmitted from the semiconductor integrated circuit (24) through the transmission line and to perform information communication with the semiconductor integrated circuit (24) through the driver information communication second terminal (210).

The interchannel phase shift determination circuit (306) includes a determination circuit (304) for determining whether with respect to a pulse signal of a reference channel of the multiple-channel pulse signals received through the driver input first terminal (209), a pulse signal of a different channel is delayed or advanced in phase and a register (305) for holding a determination result obtained by the determination circuit (304). In this case, information held in the register (305) is transmitted to the semiconductor integrated circuit (24) through the driver information communication second terminal (210).

The interchannel phase shift determination circuit (306) determines whether with respect to a pulse signal of a reference channel of the multiple-channel pulse signals received through the driver input first terminal (209), a pulse signal of a different channel is delayed or advanced in phase. With this configuration, it is possible to simplify the logical configuration of the determination circuit (306), for example, compared to the determination of a delay amount in input pulse signals. This is an advantage in reducing the number of components of the laser diode driver (300).

The interchannel phase shift determination circuit (306) can include a channel selection circuit (303) capable of selecting a pulse signal of a reference channel and a pulse signal of a different channel from among the multiple-channel pulse signals received through the driver input first terminal (209). In this case, the determination circuit (306) determines whether the pulse signal of the different channel is delayed or advanced in phase with respect to the pulse signal of the reference channel in the channels selected by the selection circuit.

By including the channel selection circuit (303), it is possible to select a pulse signal of any given channel from among the multiple-channel pulse signals received through the driver input first terminal (209).

A semiconductor integrated circuit (24) which is incorporated in an optical disk apparatus (10) including a laser diode (307) for generating laser light applied to an optical disk and a laser diode driver (300) for driving the laser diode is capable of controlling operation of the laser diode driver (300). The semiconductor integrated circuit (24) includes a write strategy circuit (202) for controlling emission of the laser diode and a control unit (143) for controlling operation of the write strategy circuit (202). The write strategy circuit (202) includes a pulse generation circuit (203) capable of generating multiple-channel pulse signals based on information for writing to the optical disk and an interchannel delay adjustment circuit (204) capable of adjusting interchannel delay in pulse signals outputted from the pulse generation circuit (203).

The control unit (143) causes the pulse generation circuit (203) to generate pulse signals for interchannel delay adjustment, and changes an interchannel delay amount in the interchannel delay adjustment circuit (204) by a predetermined adjustment unit. The control unit (143) sets the interchannel delay amount for applying laser light to the optical disk to the interchannel delay adjustment circuit (204) based on a determination result of an interchannel phase shift obtained in the laser diode driver (300) with each change of the interchannel delay amount in the interchannel delay adjustment circuit (204).

This semiconductor integrated circuit (24) is suitably incorporated in the optical disk apparatus (10) described above.

The semiconductor integrated circuit (24) can include a semiconductor integrated circuit first terminal (206) for transmitting an output signal of the interchannel delay adjustment circuit (204) to a transmission line and a semiconductor integrated circuit second terminal (207) for enabling the semiconductor integrated circuit (24) to receive the determination result of the interchannel phase shift obtained in the laser diode driver (300) with each change of the interchannel delay amount in the interchannel delay adjustment circuit (204).

With the above configuration, it is possible to transmit the output signal of the interchannel delay adjustment circuit (204) to the transmission line through the semiconductor integrated circuit first terminal (206) and to receive, in the semiconductor integrated circuit (24) through the semiconductor integrated circuit second terminal (207), the determination result of the interchannel phase shift obtained in the laser diode driver (300) with each change of the interchannel delay amount in the interchannel delay adjustment circuit (204).

The control unit (143) has a first control mode for controlling information collection for adjusting interchannel delay in the pulse signals outputted from the pulse generation circuit (203) and a second control mode for controlling application of laser light to the optical disk based on the pulse signals outputted from the pulse generation circuit (203). The control unit (143) determines in the second control mode whether or not information obtained by the laser diode driver exists in the semiconductor integrated circuit (24).

If the information obtained by the laser diode driver (300) does not exist in the semiconductor integrated circuit 924), the control unit (143) transitions to the first control mode, causes the pulse generation circuit (203) to generate pulse signals for interchannel delay adjustment, and changes an interchannel delay amount in the interchannel delay adjustment circuit (204) by the predetermined adjustment unit. At this time, the control unit (143) receives, in the semiconductor integrated circuit (24), a determination result of an interchannel phase shift obtained in the laser diode driver (300) through the semiconductor integrated circuit second terminal (207).

With the above configuration, the information obtained by the laser diode driver (300) can be stored in an appropriate storage medium such as a flash memory (144) in the semiconductor integrated circuit (24). If the information obtained by the laser diode driver (300) does not exist in the flash memory (144), the control unit (143) transitions to the first control mode, causes the pulse generation circuit (203) to generate pulse signals for interchannel delay adjustment, and changes an interchannel delay amount in the interchannel delay adjustment circuit (204) by the predetermined adjustment unit, thereby to perform information collection for interchannel delay adjustment.

If the information obtained by the laser diode driver (300) exists in the semiconductor integrated circuit (24), the control unit (143) sets the interchannel delay amount in the interchannel delay adjustment circuit (204) based on the information.

If the information obtained by the laser diode driver (300) is stored in an appropriate storage medium such as a flash memory (144) in the semiconductor integrated circuit (24), the control unit 9143) sets the interchannel delay amount in the interchannel delay adjustment circuit (204) based on the information, and can eliminate information collection for interchannel delay adjustment.

The control unit (143) determines whether or not a condition for interchannel delay amount adjustment is triggered, and if the control unit (143) determines that the condition for interchannel delay amount adjustment is triggered; whether or not the information obtained by the laser diode driver (300) exists in the semiconductor integrated circuit (24), the control unit (143) causes the pulse generation circuit (203) to generate pulse signals for interchannel delay adjustment. The control unit (143) changes an interchannel delay amount in the interchannel delay adjustment circuit (204) by the predetermined adjustment unit, and receives, in the semiconductor integrated circuit (24), a determination result of an interchannel phase shift obtained in the laser diode driver (300) through the semiconductor integrated circuit second terminal (207).

The condition for interchannel delay amount adjustment is triggered, for example, when temperature in the optical disk apparatus reaches a predetermined value. The temperature in the optical disk apparatus can be detected by a temperature sensor provided in the optical disk apparatus (10). Since an interchannel timing shift (phase shift) in the write strategy signals may occur due to device characteristic change or the like associated with a temperature rise in the optical disk apparatus, detecting when the internal temperature of the optical disk apparatus (10) reaches the predetermined value and performing interchannel delay amount adjustment as described above can improve the reliability of the optical disk apparatus.

A laser diode driver (300) which is incorporated in an optical disk apparatus (10) including a laser diode (307) for generating laser light applied to an optical disk and a semiconductor integrated circuit (24) including a write strategy circuit (202) for controlling emission of the laser diode (307) and a control unit (143) for controlling operation of the write strategy circuit (202) drives the laser diode (307) under control of the semiconductor integrated circuit (24). The laser diode driver (300) includes at least one driver input first terminal (209) for receiving multiple-channel pulse signals transmitted from the semiconductor integrated circuit (24) through a transmission line, an interchannel phase shift determination circuit (306) for determining an interchannel phase shift in the multiple-channel pulse signals received through the driver input first terminal (209), and a driver information communication second terminal (210) for enabling external output of a determination result obtained by the interchannel phase shift determination circuit (306).

The laser diode driver (300) having the above configuration is suitably incorporated in the optical disk apparatus (10) described above.

The interchannel phase shift determination circuit (306) includes a determination circuit (304) for determining whether with respect to a pulse signal of a reference channel of the multiple-channel pulse signals received through the driver input first terminal (209), a pulse signal of a different channel is delayed or advanced in phase, and a register (305) for holding a determination result obtained by the determination circuit (306). In this case, information held in the register (305) is transmitted to the semiconductor integrated circuit (25) through the driver information communication second terminal (210).

The interchannel phase shift determination circuit (306) determines whether with respect to a pulse signal of a reference channel of the multiple-channel pulse signals received through the driver input first terminal, a pulse signal of a different channel is delayed or advanced in phase. With this configuration, it is possible to simplify the logical configuration of the determination circuit (306), for example, compared to the determination of a delay amount in input pulse signals. This is an advantage in reducing the number of components of the laser diode driver.

The interchannel phase shift determination circuit (306) can include a channel selection circuit (303) capable of selecting a pulse signal of a reference channel and a pulse signal of a different channel from among the multiple-channel pulse signals received through the driver input first terminal. In this case, the determination circuit (306) determines whether the pulse signal of the different channel is delayed or advanced in phase with respect to the pulse signal of the reference channel in the channels selected by the channel selection circuit (303).

By including the channel selection circuit (303), it is possible to select a pulse signal of any given channel from among the multiple-channel pulse signals received through the driver input first terminal (209).

The laser diode driver (200) can include a current amplifier (301) for amplifying the multiple-channel pulse signals received through the driver input first terminal (209) and a digital-to-analog converter (302) for decoding a received control signal and generating a signal for controlling operation of the current amplifier (201). In this case, the driver information communication second terminal (210) is used for both transmission of information held in the register (205) and reception of a current amplifier control signal.

Since the driver information communication second terminal (210) is used both for transmission of information held in the register (305) and also for reception of the current amplifier control signal, the number of terminals of the laser diode driver (300) is reduced.

### 2. Details of Embodiments

Embodiments will be described in greater detail below.

### First Embodiment

FIG. 1 shows an example of the general configuration of an optical disk apparatus according to the invention.

An optical disk apparatus 10 shown in FIG. 1 includes a spindle motor 12 for rotationally driving a removable optical disk 11, an optical pickup 13, and a signal processing large-scale semiconductor integrated circuit (hereinafter referred to as a “system LSI”) 24 for performing signal processing. The system LSI 24, though not particularly limited, is formed over a single semiconductor substrate such as a monocrystal silicon substrate, using a known semiconductor integrated circuit manufacturing technology. The optical disk 11 for read/write by the optical disk apparatus 10 may comprise a CD (Compact Disc), a DVD (Digital Versatile Disc), or a BD (Blu-ray Disc). The rotation of the spindle motor 12 is controlled by a motor control signal 147a from the system LSI 24, thereby enabling the optical disk 11 to be rotated at a predetermined speed. The position of the optical pickup 13 is controlled by a position control signal 145a from the system LSI 24, thereby moving the optical pickup 13 to a read/write position in the radial direction of the optical disk 11. Further, laser light applied from a light emitting unit of the optical pickup 13 toward the optical disk 11 is controlled by LVDS signals 146a from the system LSI 24. With this control, pulsed laser light for read/write is applied to the surface of the optical disk 11. The laser light applied from the optical pickup 13 is reflected off the surface of the optical disk 11, and the reflected light is received by a light receiving unit of the optical pickup 13. The light receiving unit converts the reflected light into an electrical signal. The electrical signal is transmitted to the system LSI 24 and processed in a read signal processing system (not shown).

The system LSI 24 includes a microprocessor 143, a RAM (Random Access Memory) 142, a flash memory 144, a position control circuit 145, a signal processing circuit 146, and a motor control circuit 147. The microprocessor 143 is an example of a control unit in the invention and controls the overall operation of the optical disk apparatus 10. The microprocessor 143, though not particularly limited, performs arithmetic processing in accordance with predetermined programs, and is occasionally referred to as a microcomputer or a microcontroller. The RAM 142 is used as e.g. a work area for arithmetic processing by the microprocessor 143. In the flash memory 144, programs executed by the microprocessor 143 and various information for use in arithmetic processing by the microprocessor 143 are stored.

In response to a position control instruction 143a from the microprocessor 143, the position control circuit 145 outputs a position control signal 145a so as to move the optical pickup 13 to a predetermined write position or a predetermined read position. The position control signal 145a is supplied to the optical pickup 13.

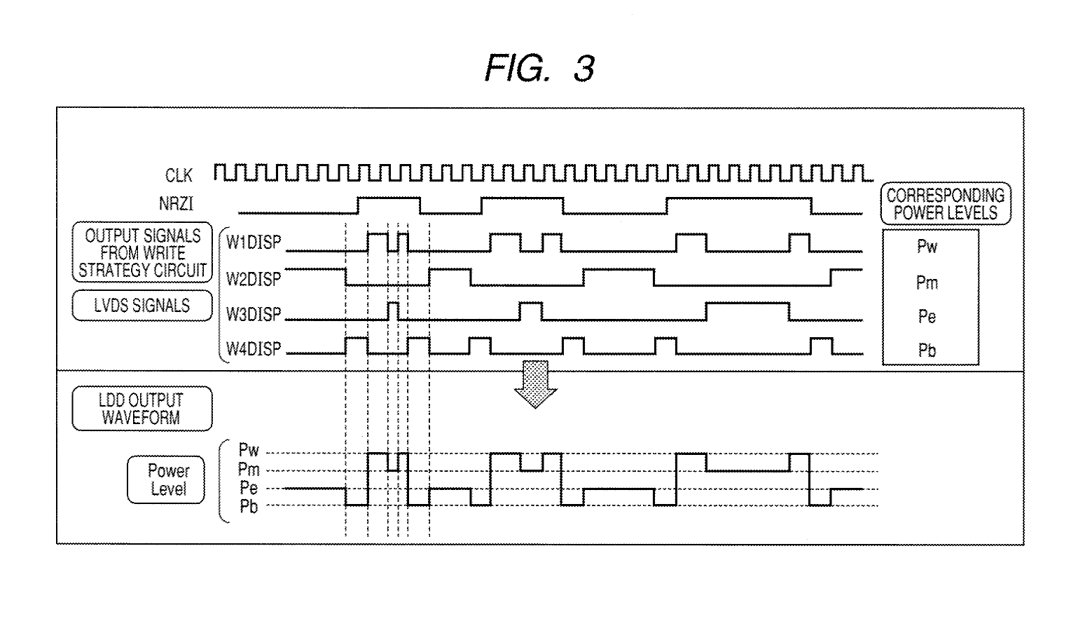

The signal processing circuit 146 generates pulse signals 146a for controlling the emission of a laser diode in the optical pickup 13. It is possible to apply a DSP to the signal processing circuit 146. The pulse signals 146a generated by the signal processing circuit 146 are, but not particularly limited to, 4-channel LVDS signals such as shown in FIG. 3, and are transmitted to the optical pickup 13 through a transmission line. In response to a motor control instruction 143b from the microprocessor 143, the motor control circuit 147 outputs a motor control signal 147a to the spindle motor 12 so as to rotate the optical disk 11 at a speed specified by the microprocessor 143.

FIG. 2 shows an example of the detailed configuration of a main part in the optical disk apparatus 10 shown in FIG. 1.

The signal processing circuit 146 includes an encoder 201 and a write strategy circuit 202. The encoder 201 generates a writing NRZI signal corresponding to the type of disk (CD, DVD, BD, or the like) currently mounted in the optical disk apparatus and an adjusting NRZI signal, under the control of the microprocessor 143. The writing NRZI signal is generated in the case of writing information to the optical disk, and the adjusting NRZI signal is generated in the case of performing interchannel delay adjustment.

The write strategy circuit 202 includes a write pulse generation circuit 203 and an interchannel delay adjustment circuit 204 disposed in a subsequent stage.

The write pulse generation circuit 203 generates 4-channel pulse signals (LVDS signals) based on the NRZI signal transmitted from the encoder 201. In the case where the writing NRZI signal corresponding to the type of disk is inputted to the write pulse generation circuit 203, the write pulse generation circuit 203 generates LVDS signals corresponding to power levels set beforehand in accordance with the type of disk, for example as shown in FIG. 3, in the case of writing information to the optical disk 11. On the other hand, in the case where the adjusting NRZI signal is inputted to the write pulse generation circuit 203, the write pulse generation circuit 203 generates rectangular pulse signals independent of the power levels. The reason why the rectangular pulse signals are generated in response to the adjusting NRZI signal is to precisely determine the delay/advance of interchannel delay as will be detailed later.

The interchannel delay adjustment circuit 204 includes a delay circuit capable of individually setting predetermined delay amounts corresponding to the 4-channel pulse signals (LVDS signals) outputted from the write pulse generation circuit 203. By setting the delay amounts to the interchannel delay adjustment circuit 204, it is possible to perform interchannel delay adjustment of the 4-channel pulse signals (LVDS signals) outputted from the write pulse generation circuit 203. The setting of the delay amounts to the interchannel delay adjustment circuit 204 can be performed by the microprocessor 143.

The system LSI 24 is provided with a plurality of semiconductor integrated circuit first terminals 206 corresponding to the output signals of the write strategy circuit 202, and the 4-channel pulse signals (LVDS signals) can be outputted to the outside through the semiconductor integrated circuit first terminals 206. Further, the system LSI 24 is provided with a semiconductor integrated circuit second terminal 207 for information communication with a laser diode driver 300 included in the optical pickup 13. The semiconductor integrated circuit second terminal 207 is coupled to the microprocessor 143.

The optical pickup 13 includes a laser diode (LD) 307 for generating laser light applied to the optical disk (not shown) and the laser diode driver (LDD) 300 for driving the laser diode 307. The laser diode driver 300 is formed over a single semiconductor substrate such as a monocrystal silicon substrate, using a known semiconductor integrated circuit manufacturing technology. The laser diode driver 300, though not particularly limited, includes a current amplifier 301, a digital-to-analog converter (DAC) 302, and an interchannel phase shift determination circuit 306. The interchannel phase shift determination circuit 306 has the function of determining an interchannel phase shift in input pulse signals under the control of the microprocessor 143, and includes a channel selection circuit 303, a delay/advance determination circuit 304, and a determination result holding register 305.

Further, the laser diode driver 300 is provided with a plurality of driver input first terminals 209 for receiving the 4-channel pulse signals outputted from the write strategy circuit 202 and a driver information communication second terminal 210 for information communication with the system LSI 24. The driver input first terminals 209, though not particularly limited, are coupled to the semiconductor integrated circuit first terminals 206 in the system LSI 24, for example, through a flexible cable 208 forming a transmission line for transmitting the 4-channel pulse signals. The current amplifier 301 combines and current-amplifies the 4-channel pulse signals (LVDS signals) received through the driver input first terminals 209, thereby generating a laser diode driving signal (see an LDD output waveform in FIG. 3) for driving the laser diode 307.

Further, the driver information communication second terminal 210 is coupled to the semiconductor integrated circuit second terminal 207 in the system LSI 24 through an information communication interface cable 308. The channel selection circuit 303 and the delay/advance determination circuit 304 can be operated by the microprocessor 143 through the information communication interface cable 308. The laser diode driver 300 can receive a control signal transmitted from the microprocessor 143 through the information communication interface cable 308. The control signal contains a signal for controlling the operation of the current amplifier 301, and the digital-to-analog converter 302 converts this signal into an analog signal, which is supplied to the current amplifier 301. The signal for controlling the operation of the current amplifier 301 contains a signal for controlling the current amplification factor of the current amplifier 301.

The channel selection circuit 303 selects a signal of a reference channel and a signal of a different channel from among the 4-channel pulse signals (LVDS signals) generated based on the adjusting NRZI signal in the write pulse generation circuit 203. The selected 2-channel signals are transmitted to the delay/advance determination circuit 304 in the subsequent stage. The delay/advance determination circuit 304 determines whether with respect to one signal of the 2-channel signals selected by the channel selection circuit 303, the other signal is delayed or advanced. Such a determination is performed each time the delay amount in the interchannel delay adjustment circuit 204 in the system LSI 24 is changed by a predetermined adjustment unit in an adjustment mode.

The determination result by the delay/advance determination circuit 304 is held in the determination result holding register 305. The information held in the determination result holding register 305 can be read by the microprocessor 143 through the information communication interface cable 308.

Further, since each channel of the write strategy signals has a different optimal emission power, a configuration in which a digital-to-analog converter and a current amplifier are provided for each channel and the amount of current of the current amplifier can be adjusted for each channel can be adopted.

Next, the operation of the above configuration will be described.

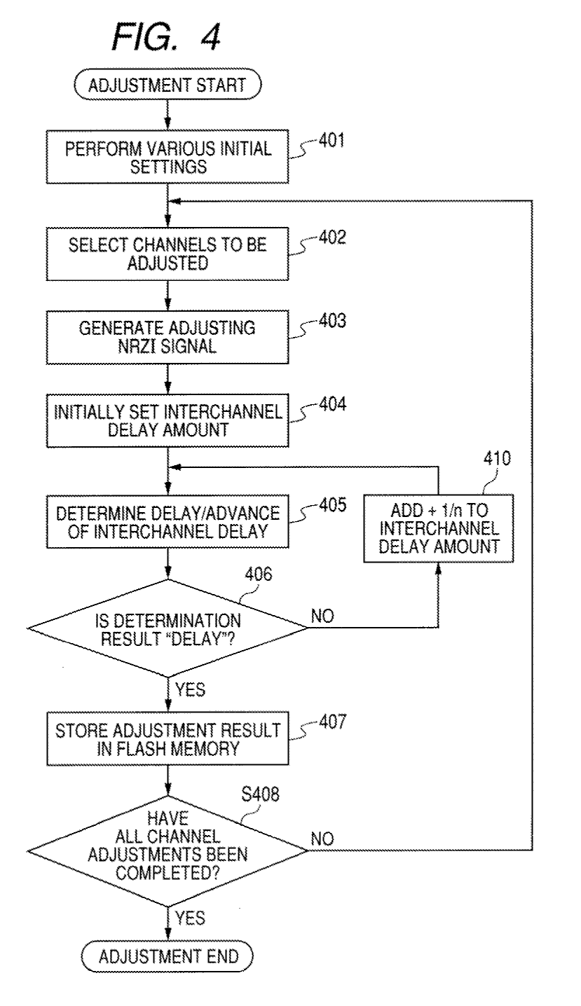

FIG. 4 shows the flow of interchannel delay adjustment of write strategy signals. The interchannel delay adjustment is controlled by the microprocessor 143. The interchannel delay adjustment control by the microprocessor 143 is referred to as a “first control mode”.

In step 401, various initial settings of each unit are performed by the control of the microprocessor 143.

In step 402, two channels for adjustment are selected from among a plurality of channels of the write strategy signals by the control of the microprocessor 143. In the channel selection, a reference channel and a comparison channel are selected. In this example, the reference channel is always the same channel. For example, assume that four channels of the write strategy signals are represented by W1, W2, W3, and W4 for convenience. In this case, W1 is the reference channel, and the other channels W2, W3, and W4 are sequentially selected to be compared with W1.

After the channels are selected in step 402, in step 403, the encoder 201 generates an adjusting NRZI signal for interchannel delay adjustment corresponding thereto, under the control of the microprocessor 143. When the adjusting NRZI signal is inputted to the write pulse generation circuit 203, the write pulse generation circuit 203 can generate rectangular wave signals for interchannel delay adjustment corresponding to the channels selected in step 402. Further, the channel selection circuit 303 selects the two channels corresponding to the channels selected in step 402 under the control of the microprocessor 143.

Then, in step 404, a delay amount is initially set for a corresponding channel in the interchannel delay adjustment circuit 204 under the control of the microprocessor 143. In this initial setting, the delay amount is set for the corresponding channel in such a way that the pulse signal of the comparison channel is changed in phases from a negative phase to a positive phase with respect to the pulse signal of the reference channel.

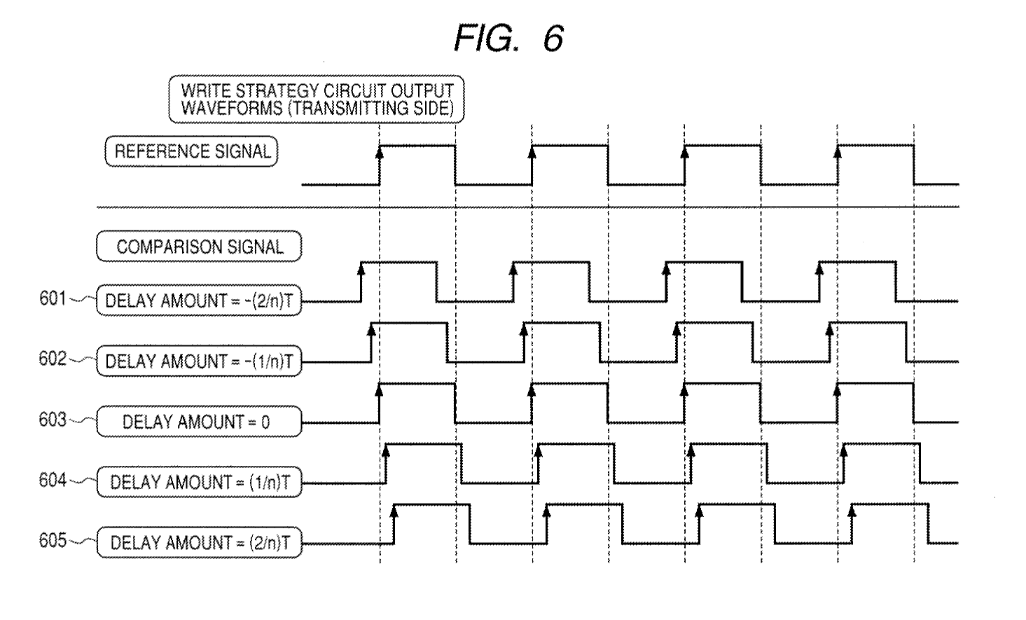

FIG. 6 shows an example of output waveforms from the write strategy circuit 202. In the example shown in FIG. 6, an initial setting is indicated by 601, and the delay amount is, but not particularly limited to, −(2/n)T. In the initial setting, a comparison pulse signal is advanced in phase by (2/n)T from a pulse signal of a reference channel (referred to as a “reference signal”). This signal is transmitted to the laser diode driver 300 through the flexible cable 208. In the laser diode driver 300, the channel selection circuit 303 selects the channels corresponding to the channel selection in step 402.

In step 405, the delay/advance determination circuit 304 determines whether the rising phase of the comparison pulse signal is delayed or advanced from that of the reference signal.

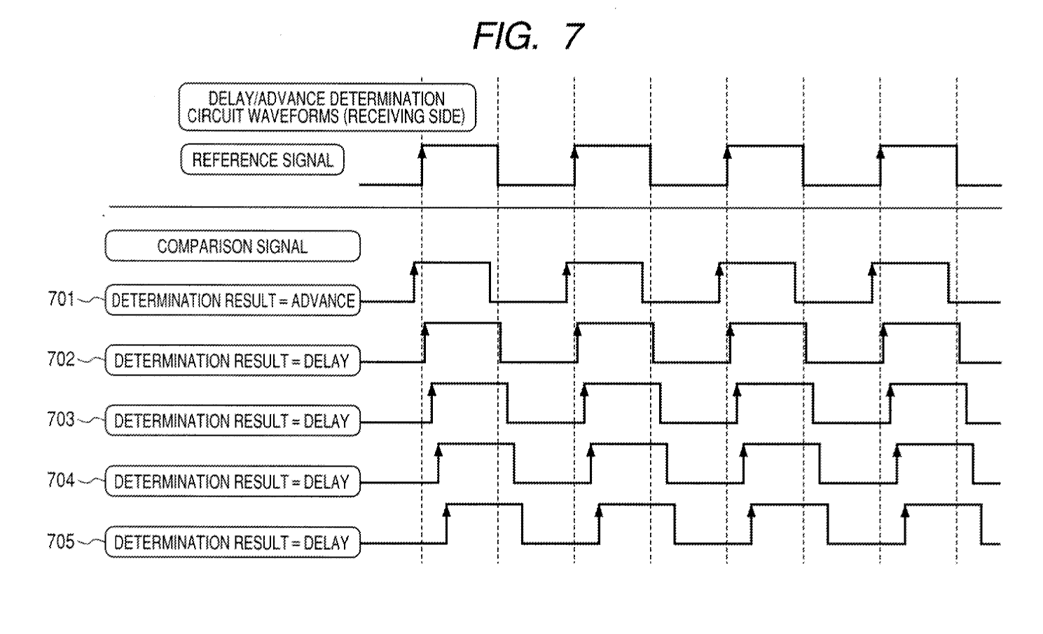

FIG. 7 shows an example of input waveforms to the delay/advance determination circuit 304 in the case where the waveforms shown in FIG. 6 are transmitted to the laser diode driver 300 through the cable 208. In the example shown in FIG. 7, the comparison pulse signal in step 405 is indicated by 701, and the rising phase of this pulse signal is advanced from (i.e., leads) that of the reference signal. Consequently, the determination result by the delay/advance determination circuit 304 is “advance”, and a logical value corresponding to the determination result is written to the determination result holding register 305. For example, a logical value “1” is written if the phase is advanced, and a logical value “0” is written if the phase is delayed. The microprocessor 143 can recognize the determination result by the delay/advance determination circuit 304 by reading the logical value in the determination result holding register 305.

In step 406, the microprocessor 143 determines whether or not the determination result by the delay/advance determination circuit 304 is “delay”.

If the microprocessor 143 determines that the determination result by the delay/advance determination circuit 304 is not “delay” (No), in step 410, the microprocessor 143 adds 1/n to the current interchannel delay amount −(2/n)T in the interchannel delay adjustment circuit 204. Accordingly, the interchannel delay amount in the interchannel delay adjustment circuit 204 is changed from −(2/n)T to −(1/n)T, as indicated by 602 in FIG. 6. After the change of the delay amount, the delay/advance determination circuit 304 loops back to step 405 to again determine whether the phase of the comparison pulse signal is delayed or advanced from that of the reference signal.

Next, in step 406, the microprocessor 143 again determines whether or not the determination result by the delay/advance determination circuit 304 is “delay”. In the case where the interchannel delay amount in the interchannel delay adjustment circuit 204 is changed to −(1/n)T as indicated by 602 in FIG. 6, the delay/advance determination circuit 304 determines that the rising phase of the comparison pulse signal is delayed from that of the reference signal (step 405) as indicated by 702 in FIG. 7, and a logical value corresponding to the determination result is written to the determination result holding register 305. Accordingly, in step 406, the microprocessor 143 determines that the determination result by the delay/advance determination circuit 304 is “delay” (Yes).

As seen from the above determination results, delay occurs in the comparison channel with respect to the reference channel, and the delay amount falls within the range of (2/n)T to (1/n)T. Therefore, by designedly generating a delay amount “−(2/n)T” or “−(1/n)T” in the comparison channel, it is possible to reduce the interchannel phase shift. In this case, whether the delay amount “−(2/n)T” or “−(1/n)T” is adopted, the interchannel delay amount falls below the resolution (1/n)T of the write pulse generation circuit 203, which produces a large adjustment effect.

In step 407, in this example, the microprocessor 143 writes a delay adjustment amount “−(1/n)T” in the channel to a predetermined write area in the flash memory 144.

Then, in step 408, the microprocessor 143 determines whether or not all channel adjustments have been completed. In this determination, if the microprocessor 143 determines that all channel adjustments have not been completed (No), the flow returns to step 402, and an interchannel delay amount in another channel is adjusted. When all channel adjustments have been completed, the flow ends.

In step 406, if it is determined that the determination result by the delay/advance determination circuit 304 is not “delay” (No), +1/n is again added to the interchannel delay amount, and determinations in steps 405 and 406 are again performed. Thus, the processing in step 410 is repeated until it is determined in step 406 that the determination result by the delay/advance determination circuit 304 is “delay” (Yes), thereby changing the interchannel delay amount in the interchannel delay adjustment circuit 204 as indicated by 603, 604, and 605 in FIG. 6.

In the case where the interchannel delay amount in the interchannel delay adjustment circuit 204 is changed as indicated by 603, 604, and 605 in FIG. 6, all the determination results by the delay/advance determination circuit 304 are “delay” as indicated by 703, 704, and 705 in FIG. 7. The important thing here is that the determination result by the delay/advance determination circuit 304 changes from “advance” to “delay” as indicated by 701 and 702 in FIG. 7, and it is only necessary to recognize this change, so that the other determinations (703, 704, 705) are not required.

According to the technique described in Patent Document 1, since pulses for use in adjustment are generated by the timing-shift detection signal generation circuit included in the DSP, and the output of the timing-shift detection signal generation circuit is transmitted to the laser diode driver by switching signal transmission paths, different signal paths are used in adjustment and in actual writing. On the other hand, in the above first control mode, information for interchannel delay adjustment is collected through the use of the same signal path as that for transmitting the 4-channel pulse signals (LVDS signals) from the write pulse generation circuit 203 to the laser diode driver 300 in actual writing, which can improve the adjustment accuracy of the interchannel phase shift in the write strategy signals.

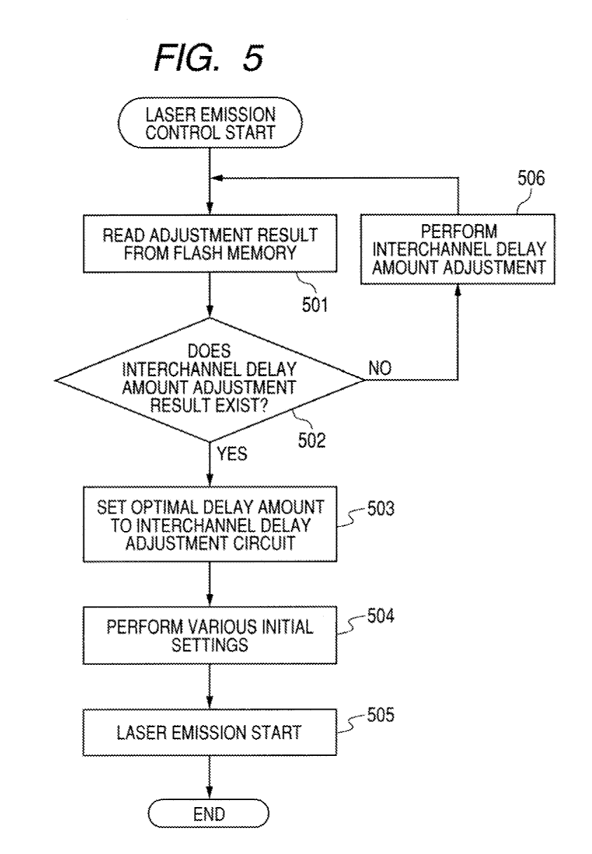

FIG. 5 shows the flow of write emission control using adjustment results obtained by interchannel delay adjustment shown in FIG. 4. The write emission control is performed by the microprocessor 143. The write emission control by the microprocessor 143 is referred to as a “second control mode”.

First, in steps 501 and 502, the microprocessor 143 accesses the flash memory 144, and determines whether or not information (interchannel delay amount adjustment result) obtained in the first control mode exists. In this determination, if it is determined that the information (interchannel delay amount adjustment result) obtained in the first control mode exists (Yes), in step 503, the information is set to the interchannel delay adjustment circuit 204.

In the case where the write strategy signals of three or more channels exist, respective optimal delay amounts are set to all channels or some channels except the reference channel. Then, in step 504, the microprocessor 143 performs various initial settings of each unit. When an NRZI signal corresponding to write data is inputted to the write pulse generation circuit 203, the write pulse generation circuit 203 generates LVDS signals (4-channel pulse signals) corresponding to the NRZI signal. The LVDS signals, each channel of which is provided with respective appropriate delay in the interchannel delay adjustment circuit 204, are transmitted to the laser diode driver 300 through the flexible cable 208. The LVDS signals (4-channel pulse signals) transmitted to the laser diode driver 300 have undergone, in the interchannel delay adjustment circuit 204, interchannel delay adjustment corresponding to the transmission line (signal path from the write pulse generation circuit 203 to the laser diode driver 300) of the system. This makes it possible to control the interchannel phase shift less than the resolution (1/n)T of the write pulse generation circuit 203, thus enabling high-accuracy transmission of the LVDS signals. Accordingly, in step 505, the laser diode driver 300 drives the laser diode 307, which can generate laser light capable of high-quality writing.

In step 502, if it is determined that the information (interchannel delay amount adjustment result) normally obtained in the first control mode does not exist (No), control flows to step 506 where interchannel delay adjustment shown in FIG. 4 is performed. Thereafter, steps 501 and 502 are carried out again, as the microprocessor 143 again accesses the flash memory 144, and determines whether or not information (interchannel delay amount adjustment result) obtained in the first control mode exists.

The setting of the delay amount to the interchannel delay adjustment circuit 204 may be performed in the process of manufacturing the optical disk apparatus 10, immediately before or during the time when a user of the optical disk apparatus 10 writes information to the optical disk 11, or at power-up. Further, there is no limitation on adjustment frequency.

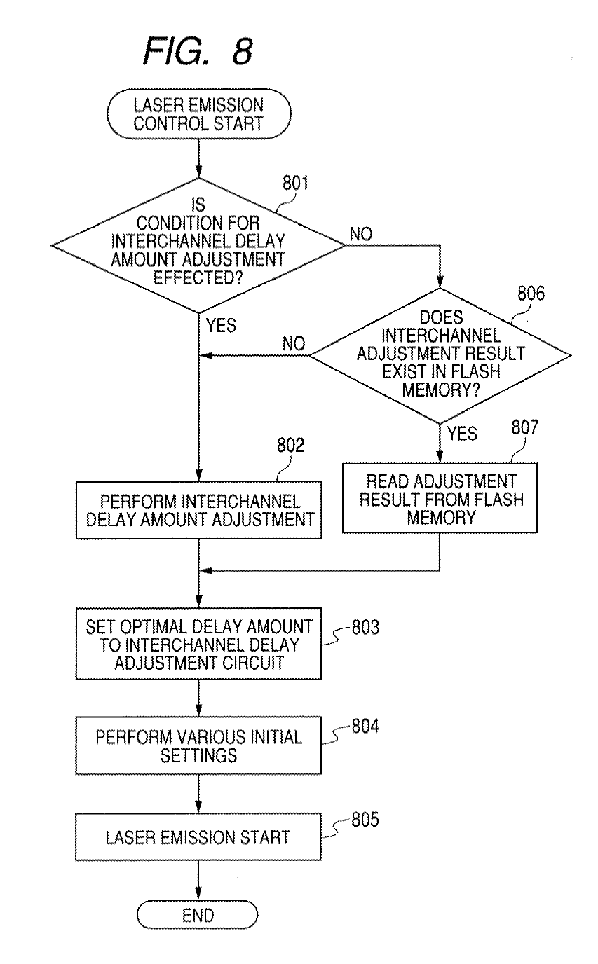

FIG. 8 shows the flow of processing for setting the delay amount to the interchannel delay adjustment circuit 204 immediately before the start of writing or in the middle of writing.

In step 801, the microprocessor 143 first determines whether or not a condition for interchannel delay amount adjustment is triggered at the start of, or in the middle of, writing information to the optical disk 11 by a user of the optical disk apparatus 10.

The condition for interchannel delay amount adjustment is triggered, for example, when temperature in the optical disk apparatus 10 reaches a predetermined value. The temperature in the optical disk apparatus 10 can be detected by a temperature sensor provided in the optical disk apparatus 10.

In step 801, if it is determined that the condition for interchannel delay amount adjustment is triggered (Yes), then control flows to 802 and interchannel delay amount adjustment is performed as in FIG. 4, whether or not the interchannel delay amount adjustment result exists in the flash memory 144. Further, in step 803, as seen in FIG. 5, the optimal delay amount is set to the interchannel delay adjustment circuit 204 and then in step 8-4, various initial settings are set prior to step 805 in which laser light capable of high-quality writing is generated.

In step 801, if it is determined that the condition for interchannel delay amount adjustment is not triggered (No), then control flows to step 806 in which the microprocessor 143 accesses the flash memory 144, and determines whether or not information (interchannel delay amount adjustment result) obtained in the first control mode exists.

If it is determined in step 806 that the information (interchannel delay amount adjustment result) obtained in the first control mode exists (Yes), then in step 807 the information is read from the flash memory 144, and control flows to step 803 to set the optimal delay amount in the interchannel delay adjustment circuit 204.

On the other hand, if it is determined in step 806 that the information obtained in the first control mode does not exist (No), then control flows to step 802 where interchannel delay amount adjustment is carried out, as described above.

Since an interchannel timing shift (phase shift) in the write strategy signals may occur due to device characteristic change or the like associated with a temperature rise in the optical disk apparatus 10, detecting when the internal temperature of the optical disk apparatus 10 reaches the predetermined value and performing interchannel delay amount adjustment as described above can improve the reliability of the optical disk apparatus 10.

The following is the reason why, in step 801, if it is determined that the condition for interchannel delay amount adjustment is triggered (Yes), interchannel delay amount adjustment is performed in step 802, whether or not the interchannel delay amount adjustment result exists in the flash memory 144.

For example, when an interchannel timing shift (phase shift) in the write strategy signals occurs due to device characteristic change or the like associated with a temperature rise in the optical disk apparatus 10, even if the delay amount is set to the interchannel delay adjustment circuit 204 using interchannel delay amount adjustment information collected before the temperature rise in the optical disk apparatus 10, appropriate interchannel delay adjustment cannot be expected. For this reason, when an interchannel timing shift (phase shift) in the write strategy signals occurs due to device characteristic change or the like associated with a temperature rise in the optical disk apparatus 10; interchannel delay amount adjustment is performed as per step 802, whether or not the interchannel delay amount adjustment result exists in the flash memory 144, and new interchannel delay amount adjustment information is collected. Thus, it is possible to appropriately correct the interchannel timing shift (phase shift) in the write strategy signals caused by the temperature rise in the optical disk apparatus 10.

### Second Embodiment

In the first embodiment, the interchannel delay amount is adjusted at the rising edge of the write strategy signal; however, it may instead be adjusted at both the rising and falling edges of the write strategy signal. The configuration of the optical disk apparatus 10 and the flow of adjustment are the same as in the first embodiment. However, the delay/advance determination circuit 304 performs phase comparison at both the rising and falling edges of a pulse signal waveform.

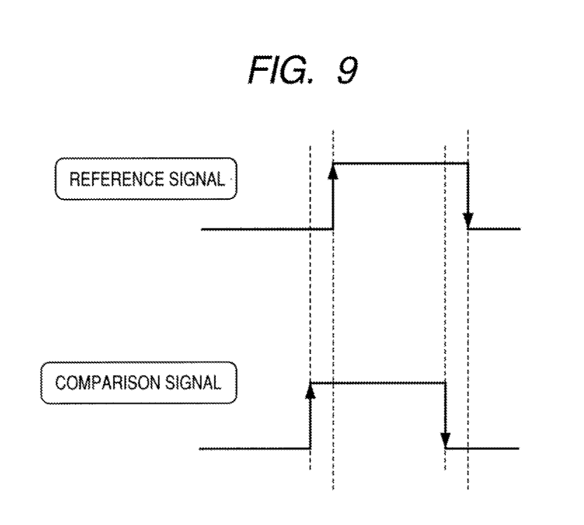

FIG. 9 shows an example in which a comparison signal is advanced in phase from a reference signal at both the rising and falling edges. It is considered that either one of the rising and falling edges is enough for phase comparison because there is little change in duration (duty) during which the signal is high, even at the time of occurrence of delay in the transmission line. However, with a higher frequency of a write clock signal, it may be necessary to adjust the interchannel shift of the duty. In this case, optimal interchannel delay amounts are set for both the rising and falling edges of the pulse signal waveform for actually writing information, thereby making it possible to reduce the interchannel shift of the duty.

Further, it is needless to say that phase comparison can be performed at only the rising edge as necessary.

While the invention made above by the present inventors has been described specifically based on the illustrated embodiments, the present invention is not limited thereto. It is needless to say that various changes and modifications can be made thereto without departing from the spirit and scope of the invention.

For example, in the first embodiment, in the first control mode by the microprocessor 143, the unit of change in the interchannel delay amount is (1/n)T, but is not limited thereto. For example, the unit of change in the interchannel delay amount can be real time (ns), which enables the interchannel delay amount to be corrected with higher adjustment accuracy. The basic configuration of the optical disk apparatus and the flow of adjustment are the same as in the first embodiment.

Further, although the write pulse generation circuit 203 generates rectangular pulse signals independent of the power levels when the adjusting NRZI signal is inputted thereto, such signals generated by the write pulse generation circuit 203 are not limited to the rectangular pulse signals as long as the signals enable phase comparison.

Furthermore, in interchannel delay adjustment, the laser diode 307 may be emitted in response to pulse signals transmitted to the laser diode driver 300, and the emission of the laser diode 307 may be inhibited by the control of the microprocessor 143.

What is claimed is:

1. An optical disk apparatus comprising:
a laser diode for generating laser light applied to an optical disk;
a laser diode driver for driving the laser diode; and
a semiconductor integrated circuit coupled to the laser diode driver via a transmission line and capable of controlling operation of the laser diode driver, the semiconductor integrated circuit including:
a write strategy circuit for controlling emission of the laser diode, the write strategy circuit including:
a pulse generation circuit capable of generating multiple-channel pulse signals based on information for writing to the optical disk; and
an interchannel delay adjustment circuit capable of adjusting interchannel delay in pulse signals outputted from the pulse generation circuit; and
a control unit for controlling operation of the write strategy circuit;
wherein:
the laser diode driver includes an interchannel phase shift determination circuit for determining an interchannel phase shift in the multiple-channel pulse signals transmitted from the semiconductor integrated circuit through the transmission line, and
the control unit causes the pulse generation circuit to generate pulse signals for interchannel delay adjustment, changes an interchannel delay amount in the interchannel delay adjustment circuit in a predetermined adjustment unit, and sets the interchannel delay amount for applying laser light to the optical disk to the interchannel delay adjustment circuit based on a determination result obtained by the interchannel phase shift determination circuit with each change of the interchannel delay amount in the interchannel delay adjustment circuit.

2. The optical disk apparatus according to claim 1, wherein the semiconductor integrated circuit includes:
a plurality of semiconductor integrated circuit first terminals for transmitting an output signal of the interchannel delay adjustment circuit to the transmission line; and
a semiconductor integrated circuit information communication terminal for enabling the semiconductor integrated circuit to receive the determination result obtained by the interchannel phase shift determination circuit with each change of the interchannel delay amount in the interchannel delay adjustment circuit.

3. The optical disk apparatus according to claim 2, wherein:
the control unit has a first control mode for controlling information collection for adjusting interchannel delay in the pulse signals outputted from the pulse generation circuit and a second control mode for controlling application of laser light to the optical disk based on the pulse signals outputted from the pulse generation circuit; and
the control unit determines in the second control mode whether or not the determination result obtained by the interchannel phase shift determination circuit exists in the semiconductor integrated circuit, and if the determination result obtained by the interchannel phase shift determination circuit does not exist in the semiconductor integrated circuit, the control unit:
transitions to the first control mode,
causes the pulse generation circuit to generate pulse signals for interchannel delay adjustment,
changes an interchannel delay amount in the interchannel delay adjustment circuit by the predetermined adjustment unit, and
receives, in the semiconductor integrated circuit, a determination result obtained by the interchannel phase shift determination circuit through the semiconductor integrated circuit information communication terminal.

4. The optical disk apparatus according to claim 3, wherein if the determination result obtained by the interchannel phase shift determination circuit exists in the semiconductor integrated circuit, the control unit sets the interchannel delay amount in the interchannel delay adjustment circuit based on the determination result.

5. The optical disk apparatus according to claim 2, wherein:
the control unit determines whether or not a condition for interchannel delay amount adjustment is triggered, and
if the control unit determines that the condition for interchannel delay amount adjustment is triggered, whether or not the determination result obtained by the interchannel phase shift determination circuit exists in the semiconductor integrated circuit, the control unit:
causes the pulse generation circuit to generate pulse signals for interchannel delay adjustment,
changes an interchannel delay amount in the interchannel delay adjustment circuit by the predetermined adjustment unit, and
receives, in the semiconductor integrated circuit, a determination result obtained by the interchannel phase shift determination circuit through the semiconductor integrated circuit information communication terminal.

6. The optical disk apparatus according to claim 1,
wherein the laser diode driver includes:
a plurality of driver input first terminals for allowing the laser diode driver to receive the multiple-channel pulse signals transmitted from the semiconductor integrated circuit through the transmission line; and
a driver information communication second terminal for enabling information communication with the semiconductor integrated circuit.

7. The optical disk apparatus according to claim 6, wherein:
the interchannel phase shift determination circuit includes:
a determination circuit for determining whether, with respect to a pulse signal of a reference channel of the multiple-channel pulse signals received through the driver input first terminals, a pulse signal of a different channel is delayed or advanced in phase; and
a register for holding a determination result obtained by the determination circuit, and
information held in the register is transmitted to the semiconductor integrated circuit through the driver information communication second terminal.

8. The optical disk apparatus according to claim 7,
wherein the interchannel phase shift determination circuit further includes a selection circuit capable of selecting a pulse signal of a reference channel and a pulse signal of a different channel from among the multiple-channel pulse signals received through the driver input first terminals, and
wherein the determination circuit determines whether the pulse signal of the different channel is delayed or advanced in phase with respect to the pulse signal of the reference channel in the channels selected by the selection circuit.

9. The optical disk apparatus according to claim 1, wherein:
the semiconductor integrated circuit includes a plurality of semiconductor integrated circuit first terminals configured to transmit a plurality of write strategy signals from the write strategy circuit to the laser diode driver;
the laser diode driver includes a plurality of driver input first terminals for receiving said plurality of write strategy signals; and
the laser diode driver is configured to generate at least one laser diode driving signal for driving the laser diode, based on the write strategy signals received by the driver input first terminals.

10. The optical disk apparatus according to claim 9, wherein:
the plurality of write signals comprises four low voltage differential signaling signals; and
the at least one laser diode driving signal comprises a waveform having at least four power levels.

11. The optical disk apparatus according to claim 1, wherein:
the laser diode driver includes a plurality of driver input first terminals;
the semiconductor integrated circuit includes a plurality of semiconductor integrated circuit first terminals connected to said plurality of driver input first terminals via the transmission line;
in a first control mode of the control unit:
the plurality of semiconductor integrated circuit first terminals outputs to the plurality of driver input first terminals via the transmission line, pulse signals which are used to adjust interchannel delay; and
in a second control mode of the control unit:
the plurality of semiconductor integrated circuit first terminals outputs to the plurality of driver input first terminals via the transmission line, pulse signals which are used to control application of laser light to the optical disk.

12. A semiconductor integrated circuit incorporated into an optical disk apparatus including a laser diode for generating laser light applied to an optical disk and a laser diode driver for driving the laser diode, the semiconductor integrated circuit capable of controlling operation of the laser diode driver and comprising:
a write strategy circuit for controlling emission of the laser diode, the write strategy circuit including:
a pulse generation circuit capable of generating multiple-channel pulse signals based on information for writing to the optical disk; and
an interchannel delay adjustment circuit capable of adjusting interchannel delay in pulse signals outputted from the pulse generation circuit, and
a control unit for controlling operation of the write strategy circuit, wherein the control unit:
causes the pulse generation circuit to generate pulse signals for interchannel delay adjustment,
changes an interchannel delay amount in the interchannel delay adjustment circuit by a predetermined adjustment unit, and
sets the interchannel delay amount for applying laser light to the optical disk to the interchannel delay adjustment circuit based on a determination result of an interchannel phase shift obtained in the laser diode driver with each change of the interchannel delay amount in the interchannel delay adjustment circuit.

13. The semiconductor integrated circuit according to claim 12, further comprising:
a plurality of semiconductor integrated circuit first terminals for transmitting an output signal of the interchannel delay adjustment circuit to a transmission line; and
a semiconductor integrated circuit second terminal for enabling the semiconductor integrated circuit to receive the determination result of the interchannel phase shift obtained in the laser diode driver with each change of the interchannel delay amount in the interchannel delay adjustment circuit.

14. The semiconductor integrated circuit according to claim 13, wherein:
the control unit has a first control mode for controlling information collection for adjusting interchannel delay in the pulse signals outputted from the pulse generation circuit, and a second control mode for controlling application of laser light to the optical disk based on the pulse signals outputted from the pulse generation circuit, and
the control unit determines in the second control mode whether or not information obtained by the laser diode driver exists in the semiconductor integrated circuit, and if the information obtained by the laser diode driver does not exist in the semiconductor integrated circuit, the control unit:
transitions to the first control mode,
causes the pulse generation circuit to generate pulse signals for interchannel delay adjustment,
changes an interchannel delay amount in the interchannel delay adjustment circuit by the predetermined adjustment unit, and
receives, in the semiconductor integrated circuit, a determination result of an interchannel phase shift obtained in the laser diode driver through the semiconductor integrated circuit second terminal.

15. The semiconductor integrated circuit according to claim 14, wherein if the information obtained by the laser diode driver exists in the semiconductor integrated circuit, the control unit sets the interchannel delay amount in the interchannel delay adjustment circuit based on the information.

16. The semiconductor integrated circuit according to claim 13, wherein:
the control unit determines whether or not a condition for interchannel delay amount adjustment is triggered, and
if the control unit determines that the condition for interchannel delay amount adjustment is triggered, whether or not the information obtained by the laser diode driver exists in the semiconductor integrated circuit, the control unit:
causes the pulse generation circuit to generate pulse signals for interchannel delay adjustment,
changes an interchannel delay amount in the interchannel delay adjustment circuit by the predetermined adjustment unit, and
receives, in the semiconductor integrated circuit, a determination result of an interchannel phase shift obtained in the laser diode driver through the semiconductor integrated circuit second terminal.

17. A laser diode driver incorporated in an optical disk apparatus, the optical disk apparatus including a laser diode for generating laser light applied to an optical disk and a semiconductor integrated circuit including a write strategy circuit for controlling emission of the laser diode and a control unit for controlling operation of the write strategy circuit, the laser diode driver configured to drive the laser diode under control of the semiconductor integrated circuit, the laser diode driver comprising:
a plurality of driver input first terminals for receiving multiple-channel pulse signals transmitted from the semiconductor integrated circuit through a transmission line;
an interchannel phase shift determination circuit for determining an interchannel phase shift in the multiple-channel pulse signals received through the driver input first terminals; and
a driver information communication second terminal for enabling external output of a determination result obtained by the interchannel phase shift determination circuit.

18. The laser diode driver according to claim 17, wherein:
the interchannel phase shift determination circuit includes:
a determination circuit for determining whether, with respect to a pulse signal of a reference channel of the multiple-channel pulse signals received through the driver input first terminals, a pulse signal of a different channel is delayed or advanced in phase; and
a register for holding a determination result obtained by the determination circuit, and
information held in the register is transmitted to the semiconductor integrated circuit through the driver information communication second terminal.

19. The laser diode driver according to claim 18,
wherein the interchannel phase shift determination circuit further includes a selection circuit capable of selecting a pulse signal of a reference channel and a pulse signal of a different channel from among the multiple-channel pulse signals received through the driver input first terminals, and
wherein the determination circuit determines whether the pulse signal of the different channel is delayed or advanced in phase with respect to the pulse signal of the reference channel in the channels selected by the selection circuit.

20. The laser diode driver according to claim 19, further comprising:
a current amplifier for amplifying the multiple-channel pulse signals received through the driver input first terminals; and
a digital-to-analog converter for decoding a received control signal and generating a signal for controlling operation of the current amplifier,
wherein the driver information communication second terminal is used for transmission of information held in the register and reception of a current amplifier control signal.

21. An optical disk apparatus comprising:
a laser diode for generating laser light applied to an optical disk;
a laser diode driver for driving the laser diode, the laser diode driver including a plurality of driver input first terminals and a driver information communication second terminal;
a semiconductor integrated circuit having a control unit configured to control the laser diode driver, the semiconductor integrated circuit including a plurality of semiconductor integrated circuit first terminals and a semiconductor integrated circuit second terminal
a first transmission line connecting the plurality of driver input first terminals to the plurality of semiconductor integrated circuit first terminals;
a second transmission line connecting the driver information communication second terminal to the semiconductor integrated circuit second terminal;
wherein:
in a first control mode of the control unit:
the plurality of semiconductor integrated circuit first terminals outputs to the plurality of driver input first terminals via the first transmission line, pulse signals which are used to adjust interchannel delay; and
in a second control mode of the control unit:
the plurality of semiconductor integrated circuit first terminals outputs to the plurality of driver input first terminals via the first transmission line, pulse signals which are used to control application of laser light to the optical disk.
